(19) United States
(12) Patent Application Publication
(10) Pub. No.: US 2009/0219391 A1
(43) Pub. Date: Sep. 3, 2009

(54) ON-CAMERA SUMMARISATION OF OBJECT RELATIONSHIPS

(75) Inventors: David Grant McLeish, Northmead (AU); Lachlan James Patrick, Westleigh (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/372,273

(22) Filed: Feb. 17, 2009

(30) Foreign Application Priority Data
Feb. 28, 2008 (AU) 2008200926

(51) Int. Cl. H04N 7/18; H04N 5/225

(52) U.S. Cl. 348/143; 348/169; 348/E05.024; 348/E07.085

(57) ABSTRACT

Disclosed herein is a method of communicating video object relationships. The method comprises the steps of: detecting one or more objects in a first video frame (303); detecting one or more objects in a second video frame; determining a first set of temporal object relationships between said objects detected in said second video frame and said objects detected in said first video frame (304); detecting one or more objects in a third video frame; determining a second set of temporal object relationships between said objects detected in said third video frame and said objects detected in said first video frame, based on said first set of temporal object relationships; and transmitting said second set of temporal object relationships to a receiver (309).

### FIELD OF THE INVENTION

The present invention relates to object detection using a video camera and, in particular, to the summarisation and transmission of detected and deduced object relationships via a network.

### BACKGROUND

Digital video transmission via communications networks has become common within video surveillance systems. However, the data bandwidth required can be much greater than for capturing and transmitting still images or sounds alone, since video transmission involves a continuous flow of image information.

The flow of information can also pose a problem to content analysis systems which employ object detection, since such systems must commonly analyse contemporaneously many streams of input to provide real-time results. For example, consider systems deployed in airports and shopping malls. Such systems typically have many cameras to provide surveillance coverage of areas of interest, including entrances and exits. Systems with many cameras produce many streams of image information to analyse.

The scalability of such systems can thus become a problem, both in terms of the network bandwidth required and the computational power needed to analyse effectively the captured scene image data.

One approach to addressing both these problems is to shift some of the content analysis work onto processors within the cameras themselves. This approach allows each camera to perform object detection on the scene it is viewing. The object data deduced by the camera can be transmitted via the same network as the video image data, allowing subsequent analysis to benefit from those results and avoid doing some of the object detection itself, thus lowering the computational expense at the back end by distributing some of the work.

Transmitting object data deduced by the cameras will slightly increase the bandwidth required, albeit not by much since the video frames themselves will consume most of the bandwidth. However, if the object detection can be used to adjust dynamically the frame rate, resolution, or a combination thereof, in response to the detection of motion or interesting events occurring within the scene being observed, then the overall bandwidth required can actually be reduced on average by allowing the system to adjust automatically as needs require.

Dynamically adjusting the frame rate, resolution, or a combination thereof, is particularly useful in situations where the bandwidth has a relatively high associated cost, such as when video updates are transmitted on a wireless telephony network. In such situations, one to five frames per second might be considered a good rate of video transmission, and each transmission might require a phone call and thus a connection charge. Thus, limiting the number of calls as well as the length of the calls or the rate of transmission can reduce costs for consumers.

Similarly, if computational power or storage has a high associated cost, for example in home security situations, then it is desirable to have cameras which can make intelligent decisions about what volume of video data to transmit and to adjust that volume dynamically whenever an interesting event occurs.

### SUMMARY

A method to condense and summarise object relationships detected using a video camera is described. A video camera system including an object detection subsystem with an object tracker component is used to detect objects within a viewed scene. A list of inferred object relationships is built using object relationships established by the object detection subsystem. These inferred relationships are maintained and condensed to match a set of objects currently being tracked by the object detection subsystem.

When object data, including object relationships and optionally video frames, are sent to receivers via a network, the condensed summaries are transmitted instead of, or in addition to, complete summaries of the object interactions. Various transmission criteria can be used to trigger transmission of such data. This allows interesting events, such as the abandonment, removal or exchange of objects, to be detected and details of such object interactions to be preserved, even if video frames showing that event are never transmitted to receivers. Transmitting condensed summaries facilitates bandwidth reduction, distributed object detection, and multiple receivers being sent object data and optionally video frames from the same camera at different rates while still receiving object data pertinent to information each receiver has received previously.

According to a first aspect of the present disclosure, there is provided a method of communicating video object relationships, comprising the steps of:
(a) detecting one or more objects in a first video frame;
(b) detecting one or more objects in a second video frame;
(c) determining a first set of temporal object relationships between said objects detected in said second video frame and said objects detected in said first video frame;
(d) detecting one or more objects in a third video frame;
(e) determining a second set of temporal object relationships between said objects detected in said third video frame and said objects detected in said first video frame, based on said first set of temporal object relationships; and
(f) transmitting said second set of temporal object relationships to a receiver.

According to a second aspect of the present disclosure, there is provided a system comprising:

a source of video frames;

an object detection subsystem for receiving video frames from said camera and detecting objects in said video frames, said object detection subsystem including a tracking means for determining relationship information between said detected objects and objects detected in preceding video frames; and

a communication subsystem for transmitting said relationship information to a receiver.

In one embodiment, the source of video frames is a video camera.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects of the present disclosure are also disclosed.

### BRIEF DESCRIPTION OF THE DRAWINGS

FIG. 1 is a block diagram showing a camera system in accordance with an embodiment of the present disclosure;

FIG. 2 is a flowchart illustrating operation of an embodiment of the present disclosure in which there is only one receiver;

FIG. 3 is a flowchart illustrating operation of an embodiment of the present disclosure in which there are many receiver sets;

FIG. 4 is a diagram illustrating example frames and objects detected by a camera system and the relationships determined from those detected objects;

FIG. 5 is a schematic representation of object relationships established in accordance with an embodiment of the present disclosure;

FIG. 6 illustrates processing of video frames in accordance with a camera system of the present disclosure having multiple receivers;

FIG. 7 is a block diagram showing a an embodiment of a camera system in accordance with the present disclosure having multiple receiver sets;

FIG. 8 shows a schematic block diagram of a camera upon which methods of FIGS. 1 to 7 may be practised;

FIG. 9 is a block diagram showing a camera system in accordance with an embodiment of the present disclosure integrating the camera with object detection and communication subsystems;

FIG. 10 is a diagram illustrating a graphical user interface displaying objects and relationships determined in accordance with an embodiment of the present disclosure; and

FIG. 11 is a block diagram illustrating a process of modifying a JPEG file to add relationship data into the JPEG file using an application-specific data block.

### DETAILED DESCRIPTION

Where reference is made in any one or more of the accompanying drawings to steps and/or features that have the same reference numerals, those steps and/or features have for the purposes of this description the same function(s) or operation(s), unless the contrary intention appears.

It is to be noted that discussions relating to prior art arrangements relate to devices which may form public knowledge through their use. Such discussions should not be interpreted as a representation by the present inventors or patent applicant that such devices in any way form part of the common general knowledge in the art.

Disclosed herein is a method of summarising and condensing temporal object relationships. A temporal object relationship is a relationship between two or more objects detected or inferred from an output of a video camera. For example, if a person puts a suitcase on the floor and then the person walks away from the suitcase, that is termed a “split” relationship between those two objects, wherein the first object is the person and the second object is the suitcase. If the person subsequently returns and picks up the suitcase, that is termed a “merge” relationship between the person and the suitcase. Similarly, if a person walks past a camera, in each video frame recorded by the camera the shape of the person is related to the shape of that person in a preceding frame, which is termed a “self” relationship. The “self” relationship provides information relating to the same object over time. Deducing such relationships requires viewing or analysing a scene over time, and hence these relationships have a temporal component. Where the phrase “object relationship” is used below, the word “temporal” is implied.

In accordance with an embodiment of the present disclosure for communicating video object relationships, a method is disclosed that detects one or more objects in a first video frame and subsequently detects one or more objects in a second video frame. The first and second video frames need not be consecutive frames. The method determines a first set of temporal object relationships between the objects detected in the second video frame and the objects detected in the first video frame. The method then detects one or more objects in a third video frame. Again, the third video frame need not be consecutive with the first and second frames, and intermediate frames may be located between the first and second frames and the second and third frames, respectively.

The method then determines a second set of temporal object relationships between the objects detected in the third video frame and the objects detected in the first video frame, based on the first set of temporal object relationships. The method then transmits the second set of temporal object relationships to a receiver.

In accordance with another embodiment of the present disclosure, there is provided a system. The system comprises a source of video frames, an object detection subsystem and a communication subsystem for transmitting the relationship information to a receiver. The object detection subsystem receives video frames from the camera and analyses the video frames to detect objects in the video frames. The object detection subsystem includes a tracking means for determining relationship information between detected objects in a current video frame and objects detected in at least one preceding video frame. In one embodiment, each subsystem is implemented in hardware. In a further embodiment, each subsystem is implemented using hardware and firmware instructions.

A camera may be used to capture video frames representing the visual content of a scene appearing in the field of view of the camera. In the case of a pan-tilt camera, the orientation of the camera may be altered to change the field of view. The camera may therefore capture video frames of a scene, with the scene being larger than the field of view of the camera.

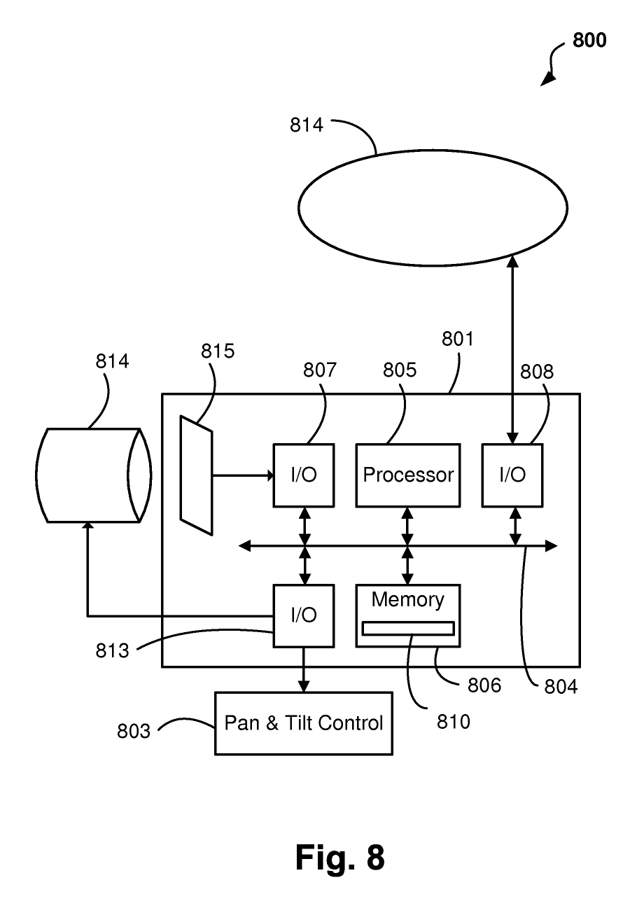

FIG. 8 shows a functional block diagram of a camera 800 upon which embodiments of the present disclosure may be practised. The camera 800 is a pan-tilt-zoom camera (PTZ) comprising a camera subsystem 801, a pan and tilt subsystem 803, and a lens subsystem 814. The camera subsystem 801 typically includes at least one processor unit 805, and a memory unit 806, a photo-sensitive sensor array 815, an input/output (I/O) interface 807 that couples to the sensor array 815, an input/output (I/O) interface 808 that couples to a communications network 814, and an interface 813 for the pan and tilt subsystem 803 and the lens subsystem 814. The components 807, 805, 808, 813 and 806 of the camera subsystem 801 typically communicate via an interconnected bus 804 and in a manner which results in a conventional mode of operation known to those in the relevant art.

Each frame captured by the camera 800 comprises more than one visual element. A visual element may be defined as an image sample. In one arrangement, the visual element is a pixel, such as a Red-Green-Blue (RGB) pixel. In another embodiment, each visual element comprises a group of pixels. In yet another embodiment, the visual element is an 8 by 8 block of transform coefficients, such as Discrete Cosine Transform (DCT) coefficients as acquired by decoding a motion-JPEG frame, or Discrete Wavelet Transformation (DWT) coefficients as used in the JPEG-2000 standard. The colour model is typically YUV, where the Y component represents the luminance, and the U and V represent the chrominance.

Embodiments of the present disclosure may equally be practised on a fixed camera system that does not have pan and tilt functionality. Alternatively, rather than receiving video frames from a camera, video frames can equally be retrieved from a source of video frames. In one embodiment, the source of video frames is a storage medium, such as a hard disk drive, a Digital Versatile Disc (DVD), Compact Disc (CD), flash memory.

One or more of the embodiments described herein are intended to work within such dynamic systems as described above, in particular with the assumption that object detection is achieved in the camera and results are sent to observers via a communications network, with or without the corresponding video frames.

Typically, a video camera records information onto a number of successive frames at a predetermined frame rate. Video frames from the camera are transferred to an object detection subsystem. In one embodiment, the object detection subsystem resides inside the camera in either hardware or firmware, or a combination thereof, and the video frames are transferred via an electrical bus. In an alternative embodiment, the object detection subsystem resides on another computer, and the video frames are transferred from the camera to the other computer by means of a network or any communication link.

In one embodiment, video frames are transferred from the camera to the object detection subsystem at a regular time interval. The object detection subsystem analyses each video frame to detect regions of each video frame that correspond to one or more objects. The object detection subsystem also determines which of the detected regions correspond to one or more regions in the immediately preceding previously analysed video frame—hereafter referred to as object relationships. The temporal nature of these relationships is implicit in the remainder of this description, as the relationships are established with reference to video frames over time.

The object detection subsystem transfers object regions and object relationships related to each frame to a communication subsystem. In one embodiment, the object regions and object relationship data is transferred by means of an electrical bus or shared memory. In an alternative embodiment, the communication subsystem resides on another computer, and the object regions and object relationship data are transferred by means of a network or other communications channel.

The communication subsystem acts as a network server, and receives connection requests from potential receivers via a network or other communications channel. Such connection requests are allowed or disallowed according to connection criteria. The connection criteria can include, for example, but are not limited to, resource limits, security negotiations, and other connection methods. The connection criteria can be defined before the system commences operation, determined during operation of the system, defined by a user, or a combination thereof. The communication subsystem maintains connection information for each receiver that is allowed to connect to the system.

A “transmission criterion” is defined as a decision method that determines, for each frame, whether the communication subsystem should transmit the object relationship information related to that frame to one or more receivers.

One useful possible transmission criterion is a fixed rate transmission time interval. That is, the object relationship information is transmitted if at least a particular regular time interval has elapsed since the previous transmission of object relationship information. In one embodiment, the communication subsystem maintains a time variable holding the time that the next transmission should occur. Whenever the transmission criterion is checked, the system determines whether the current time is later than or equal to the time value stored in the variable and, if so, the communication subsystem transmits the object relationship information to the appropriate receivers, and adds the transmission time interval to the variable holding the time when the information should have been transmitted. This averages to the correct transmission rate rather than lagging behind the correct transmission rate.

In another embodiment, other transmission criteria relate to properties of the information received from the object detection subsystem. For example, one further example of a transmission criterion requires that a merge or split relationship has been detected before transmission occurs. Similarly, another transmission criterion specifies that transmission only occurs when a detected object moves into or out of a designated region that the camera is viewing. In one embodiment, the designated region is predefined. In another embodiment, the designated region is defined by a user. Yet another transmission criterion only evaluates to true when at least a given number of objects are detected in a scene.

A more sophisticated compound transmission criterion decides between two other criteria based on properties of the information received from the object detection subsystem. For example, in one embodiment a transmission criterion specifies that object relationship information is sent when at least a given number of objects are detected in a scene and a fixed interval has elapsed since the previous transmission; or, if fewer than the given number of objects are detected, then object relationship information is sent if another, longer interval has elapsed since a previous transmission of object relationship information.

In an alternate embodiment, transmission criteria depend on external events, such as a request from a receiver, a clock mechanism reaching a certain time or date, a signal from an external system, such as a motion detector, magnetic window sensor, door opening sensor, or any combination thereof.

The communication subsystem logically groups receivers into receiver sets. Preferably, each receiver sends a request to the communication subsystem, wherein the request identifies a receiver set into which that particular receiver is to be placed.

Each receiver set has an associated transmission criterion, which may be evaluated to a value of either true or false. The value of “true” means that the communication subsystem should transmit information, whereas “false” means that the communication subsystem should not transmit information. The transmission criterion for a receiver set is evaluated at various times to allow transmissions to vary according to whether interesting occurrences have been detected in the scene since the previous transmission.

In a simple embodiment, a receiver simply specifies a transmission criterion to be associated with that particular receiver. The communication subsystem then creates a receiver set with that transmission criterion, with the receiver set containing only that receiver.

In another embodiment, the communication subsystem checks to see whether a receiver set already exists with a requested transmission criterion of a new receiver and, if so, adds that new receiver to the existing receiver set. If a receiver set with the requested transmission criterion does not exist, the communication subsystem then creates a new receiver set containing only that new receiver.

In another embodiment, the communication subsystem has a predefined collection of receiver sets, each receiver set being associated with a different transmission criterion, and each receiver selects one of the predefined receiver sets.

In yet another embodiment, one receiver creates a receiver set and an associated transmission criterion, then other receivers join that receiver set. This allows all receivers within that particular receiver set to receive the same data.

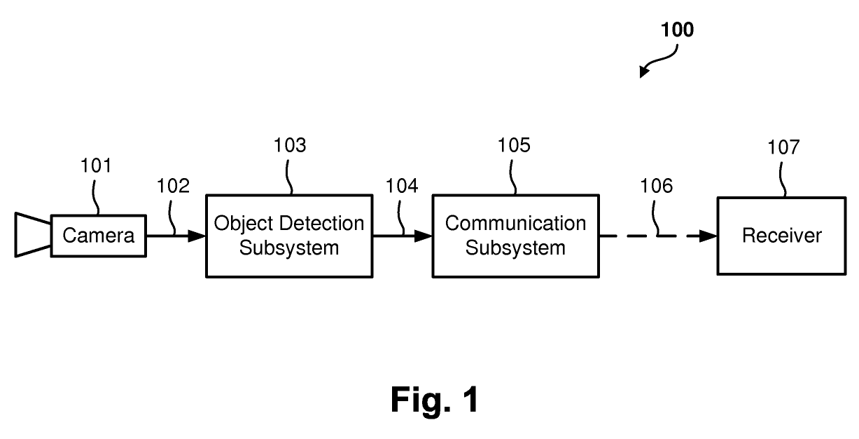

FIG. 1 is a schematic block diagram representation of a system 100 in accordance with the present disclosure. The system 100 includes a camera 101, an object detection subsystem 103, a communication subsystem 105, and a receiver 107.

The camera 101 captures a video frame and sends the captured video frame to the object detection subsystem 103. The camera 101 is coupled to the object detection subsystem 103 using a an electrical bus, shared memory, network, or other transmission link 102. The network can be a physical transmission link or a wireless transmission link.

The object detection subsystem 103 receives the captured video frame and analyses the video frame to identify which regions of the frame correspond to an object of interest in the scene. The object detection subsystem 103 then determines which of these identified regions are related to one or more object regions that were identified in a previous video frame to create object region information.

Many object detection techniques are known in the art, and the system 100 may equally practise any one of the known object detection techniques. For example, one object detection method that can be utilised is frame differencing. Another object detection method that can be utilised is background modelling based on Gaussian models. Another object detection method that can be utilised, and which is in-keeping with the spirit of this disclosure, is to use electrical or photon pulses generated by the arrival of photons on a sensor, without explicitly capturing entire frames of image data at regular intervals. Whichever method is used to detect objects, a tracker component of the object detection subsystem is responsible for determining how objects detected in the current frame relate to objects detected in a previous frame. Again, this tracker component may use any tracking method known to those skilled in the art. For instance, chromatic features of an object may be used to relate that object to an object from a previous frame, or size information may be used, or shape information, or trajectories, or even more computationally expensive methods such as face detection. This tracker component may retain information relating to just the previous frame, or the tracker component may keep information relating to several previous frames. Both of these are in-keeping with embodiments of the present disclosure.

The object detection subsystem 103 prepares the object region information for transmission to the communication subsystem 105 via an electrical bus, shared memory or network 104. The communication subsystem 105 then uses an electrical bus, shared memory or network 106 to transmit information to the at least one receiver 107.

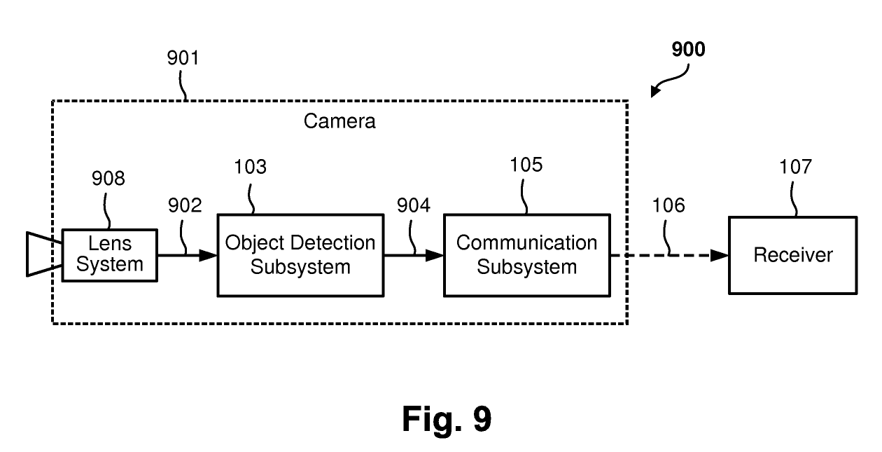

FIG. 9 is a block diagram that shows one embodiment of a camera device 900, in which the object detection subsystem 103 and communication subsystem 105 are physically contained within a single integrated camera device 901. The camera device 901 includes a lens subsystem 908, which passes information via an electrical bus or shared memory 902 to the object detection subsystem 103. The object detection subsystem 103 detects objects and passes the information so produced via an electrical bus or shared memory 904 to the communication subsystem 105, which then uses an electrical bus, shared memory or network 106 to transmit information to the at least one receiver 107.

In one embodiment, the object detection subsystem 103 associates an identifier with each detected object. The object detection subsystem also associates with each detected object a set of identifiers which correspond to detected objects that were detected in the previous frame (which are termed previously detected objects). There are two ways that a detected object can be identified as being related to a previously detected object:

(i) the detected object can share an identifier with a previously detected object; or

(ii) the detected object can have a distinct identifier, but a mapping between the identifier associated with the detected object and a previous identifier is transmitted.

In one embodiment, no semantic difference is implied by these different means of signifying a relationship. In another embodiment, a currently detected object is considered to be more closely related to a previously detected object with which the currently detected object shares an identifier, than to a previously detected object whose identifier is associated with the currently detected object via a mapping. For the remainder of this description, a relationship between two objects may be specified by either of these two means.

If a detected object is related to a previously detected object, then the previously detected object is said to be a parent of the object detected in the current frame, and the object detected in the current frame is said to be a child of the object detected in a previous frame.

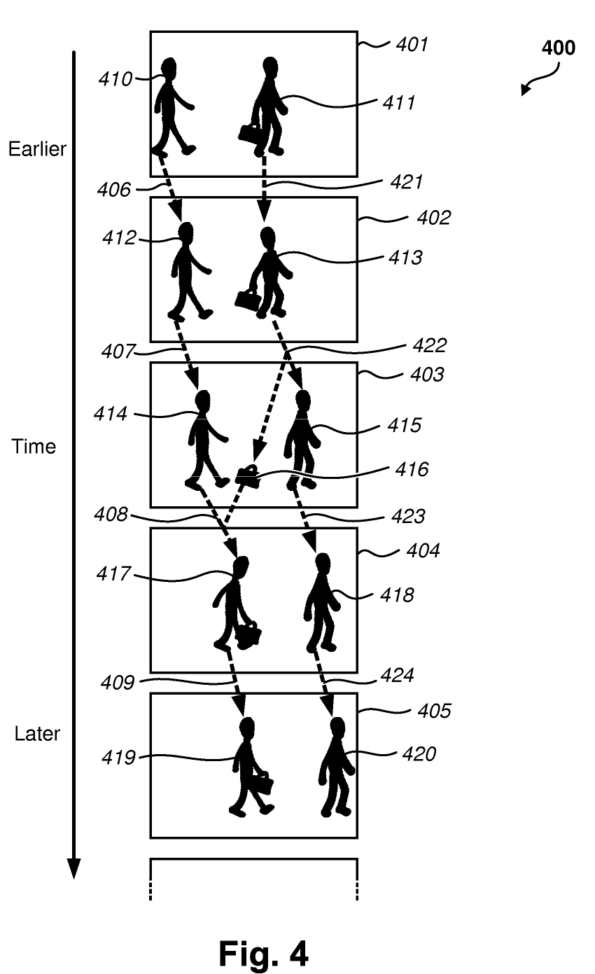

Examples of situations in which objects are said to be related to one or more objects in a previous frame are now described with reference to FIG. 4, which illustrates exemplary frames from the system 100.

FIG. 4 shows a first frame 401 depicting a first person 410 on the left hand side of the frame 401. The first frame 401 also depicts a second person holding a suitcase in the middle of the frame 401. The second person holding the suitcase is identified by the object detection subsystem 103 as a single object 411.

A second frame 402 shows a first person 412 on the left hand side of the frame and a second person holding a suitcase in the middle of the frame 402. The second person holding the suitcase is identified by the object detection subsystem 103 as a single object 413. Each of the first person 412 and the second person 413 have moved slightly to the right of the frame 402 relative to the position of the first person 410 and the second person 411 in the first frame 401.

A third frame 403 shows a first person 414 on the left hand side of the frame, a suitcase 416 in the middle of the frame 403, and a second person on the right hand side of the frame 403.

A fourth frame 404 shows a first person holding a suitcase in the middle of the frame and a second person on the right hand side of the frame 404. The first person holding the suitcase is identified by the object detection subsystem 103 as a single object 417.

A fifth frame 405 shows a first person holding a suitcase in the middle of the frame and a second person 420 on the right hand side of the frame. The first person holding the suitcase is identified by the object detection subsystem 103 as a single object 419.

As described above, if a detected object is determined by the object detection subsystem 103 to be substantially the same as a previously detected object from a previous frame, then the detected object is a child of that previously detected object. For example, in FIG. 4 such self relationships are shown as:

(i) arrow 406 joining the first person 410 from the first frame 401 with the first person 412 in the second frame 402; and

(ii) arrow 421 joining the second person 411 from the first frame 401 with the second person 413 from the second frame 402.

If two or more detected objects are determined by the object detection subsystem 103 to have split from a single object detected in a previous frame, then each of the currently detected objects is a child of that single previously detected object. For example, a split 422 is shown in FIG. 4 with reference to frames 402 and 403. Frame 402 shows the second person holding a suitcase as a single object 413. The next frame 403 shows the suitcase 416 and the second person 415 as separate objects. Each of the suitcase 416 and the second person 415 in frame 403 have split from the single object 413 from frame 402.

If a detected object is determined to be related to the merge of two or more previously detected objects, then each of the previously detected objects is a parent of the current detected object. For example, a merge 408 is shown in FIG. 4 with reference to frames 403 and 404. Frame 403 shows the first person 414 and the suitcase 416 as separate objects. In the next frame 404, the first person holding the suitcase is identified as a single object 417. Thus, the arrow 408 indicates that the first person holding the suitcase 417 in frame 404 is derived from the merger of the first person 414 and the suitcase 416 from the frame 403.

If the object detection subsystem 103 determines that two detected objects in a current frame correspond to separate detected objects in a previous frame, but that another intermediate detected object has split from one object and merged into the other object between the previous and current frames, then each object in the current frame is a child of the corresponding object detected in the previous frame. Additionally, the currently detected object into which the intermediate detected object merged is a child of the previously detected object from which the intermediate object split.

For example, in FIG. 4 the object 419 relating to the person carrying the briefcase in the middle of the last frame 405 is logically a child of the person on the right 411 within the first frame 401. This is because the split 422 between frame 402 and frame 403 made the briefcase 416 a child of the person on the right 413 in the previous frame 402. The person 414 on the left of frame 403 then merged 408 with the briefcase 416, making the person 419 carrying the briefcase in frame 405 a child of both the briefcase 416 in the middle frame 403 and the person on the right 411 in the first frame 401. In addition, self relationships (406, 407, 409, 421, 423, 424) ensure that an object is a child of any corresponding object in the previous frame. Thus, the person 420 on the right in the last frame 405 is logically a child of the person 418 on the right in the previous frame 404, and indeed the person 420 on the right in the last frame 405 is logically a child of the person 411 on the right in the first frame 401. The person with the suitcase 419 in the middle in the last frame 405 is logically a child of both the person 410 on the left and the person 411 on the right in the first frame 401.

The object detection subsystem 103 transmits this relationship information to the communication subsystem 105.

Each receiver set maintained by the communication subsystem 103 has an associated set of inferred object relationships. The inferred object relationships include mappings from object identifiers, each of which corresponds to an object detected in a current frame, to sets of object identifiers of objects detected in previous frames. The sets of object identifiers of objects detected in previous frames represent parents of one or more currently detected objects.

Referring again to FIG. 4, the parent of the person 419 in the middle in the last frame 405 may be inferred to be related in some manner to the person 411 on the right in the first frame 401 without requiring intermediate relationships (421, 422, 408, 409) or intermediate frames (402, 403, 404) to be transmitted. All that is required is that an inferred object relationships list is maintained.

When the communication subsystem is given new object relationship information, the communication subsystem handles this information with regard to each receiver set using the following steps.
1. Add new objects to the receiver set's list of inferred object relationships. For each object in the current frame, if that object does not have an entry in the inferred relationships list, add an entry for that object, with an empty set of parents. This ensures that any newly detected objects are included in future reports. Examples of newly detected objects may include, for example, people entering a scene from an edge of the frame or through a doorway within a frame.
2. For each given new object relationship, if information concerning the parent object was transmitted in the previously transmitted frame, add that parent object to each of its child objects' sets of parents, within the inferred object relationships list. This ensures that any parent objects already known to a particular receiver set will be included in future reports.
3. For each given new object relationship, if the parent object is listed in the set of inferred relationships, add all of that parent's inferred parents to each of its children's inferred set of parents. This ensures each object's ancestors will be included in future reports, which means intermediate objects detected but not reported can still be used to relate future objects to previously reported objects. For example, in FIG. 4 the briefcase 416 in the middle frame 403 is used to relate the person in the middle 419 in the last frame 405 to the person on the right 411 in the first frame 401, via split and merge relationships 422 and 408, respectively.
4. Optionally remove from the inferred relationships list all relationships concerning objects that are no longer being tracked by the object detection subsystem. This cleans up the inferred relationships list by omitting objects which are not relevant anymore. For example, those objects which are no longer visible might not be tracked, thereby preventing the list from growing in an unbounded manner over time.
5. Evaluate the receiver set's transmission criterion. If the transmission criterion evaluates to true, then: encode the receiver set's inferred object relationships list; transmit this encoded information to each of the receiver set's receivers; and then clear the receiver set's inferred object relationships. Since those receivers are now up to date on the current state of their receiver set, the list of inferred relationships can be emptied so the process can begin again.

For a particular receiver, a child object's inferred parents include the child object's parents' parents, relating all the way back to the previous object information transmitted to that same receiver. The inferred relationships list carries this information forward until the information is transmitted.

Referring again to FIG. 4, if data concerning only the first frame 401 and the last frame 405 are transmitted to a receiver, the parent-child relationship relating the second person 411 from frame 401 with the first person 419 from frame 405 can be transmitted, even if other data concerning intermediate frames 402, 403 and 404 are not explicitly transmitted. In addition, the self relationships relating the first person 410 from frame 401 with the first person 419 from frame 405 and relating the second person 411 from frame 401 with the second person 420 from frame 405 can also be transmitted. This relationship information allows the receiver to relate the two frames (401 and 405) it knows about without needing to know all about any transient intermediate objects such as the briefcase 416.

A further embodiment of the present disclosure explicitly reports to the receiver 107 whether an object has been newly detected or removed from the tracker's list of objects since the last transmission to that receiver. In such an embodiment, step 4 is removed from the above process. As noted, this could cause the inferred relationships list to grow over time. This is not a problem if the receiver set's transmission criterion is guaranteed to evaluate to true periodically, so that the list can be completely cleared by step 5 in the above process. For example, if the transmission criterion tested that a fixed time interval had elapsed, then the inferred relationships list could not grow forever. The memory available to store the inferred relationships list will affect the feasibility of this extension. This extension can make use of other list pruning methods. For instance, relationships of interest to a particular application, such as those involving merges and splits, might be kept preferentially while other information is condensed or discarded.

In addition to the aforementioned transmission criteria, further criteria are possible. For example, the extension mentioned in the previous paragraph involves keeping information about objects which have been removed from the tracker's list of objects. In one embodiment, a transmission criterion involves transmitting information about objects which have been removed from the tracker's list of objects when the inferred relationships list grows beyond a threshold, such as a particular size in memory or beyond a particular number of objects or relationships. The threshold may be predefined, predetermined, or user-defined. This transmission criterion allows information to be summarised on the camera system, but is sent in bursts to receivers.

In another embodiment, transmission criteria involves the status of the object detection subsystem or tracking component or communication subsystem or other camera subsystems. Such criteria may include, for example, an indication of whether the camera is instructed to move, change focus or zoom, or if the number of receivers or receiver sets reaches a limit, or if the tracking accuracy increases or decreases beyond a threshold; each of these can be utilised in various embodiments, either alone or in combination with each other, to trigger transmissions of object relationships.

An embodiment of the present disclosure thus provides a method to condense and summarise temporal object relationships for later transmission to receivers.

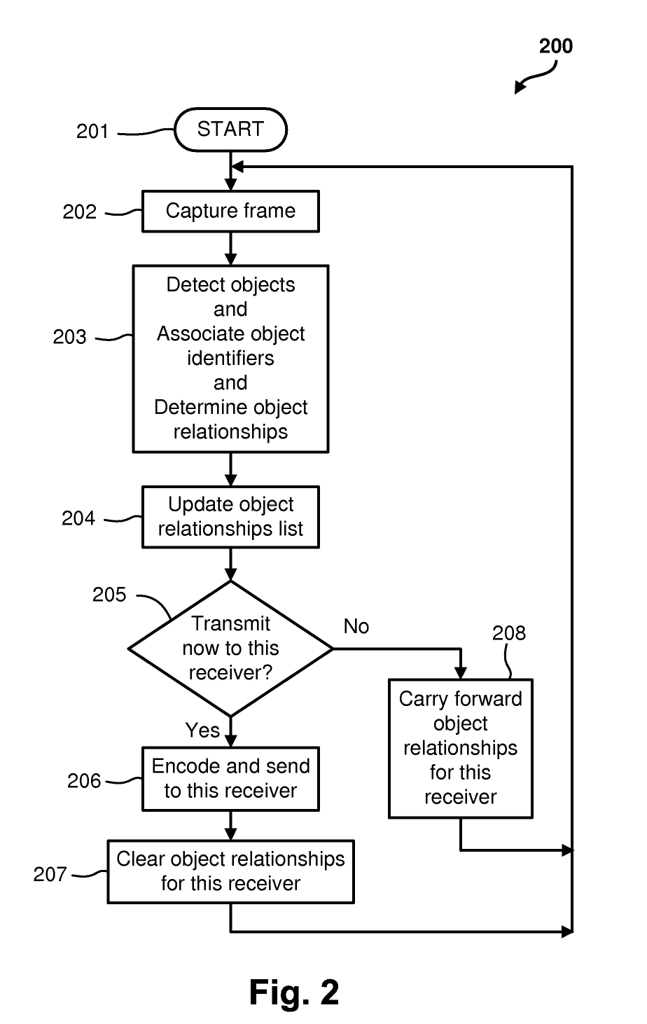

FIG. 2 is a flowchart illustrating a method 200 for condensing and summarising temporal object relationships for a single receiver. The method 200 begins at a Start step 201 that initialises the system and control passes to step 202, in which a frame is captured. Control then passes to an object tracking method step 203. The object tracking method step 203 detects objects in the captured frame and associates object identifiers with the detected objects. The object tracking method step 203 also determines object relationships among the detected objects. Such relationships may include, for example, split and merge relationships. As described above, there are many known techniques for performing object tracking.

Control passes from step 203 to step 204, which updates an object relationships list using object relationships information determined in step 203. Control then passes to a decision step 205, which determines whether to transmit accumulated object relationship information to a receiver. This step is equivalent to evaluating a transmission criterion. Further, step 205 may optionally be utilised to determine whether or not to transmit one or more frames to the receiver.

If step 205 determines that accumulated relationship information is not yet to be transmitted to a receiver, No, control passes to step 208. Step 208 condenses and summarises the object relationships, as described above, by utilising an inferred relationships list. Control returns from step 208 to step 202.

If step 205 determines that accumulated relationship information is to be transmitted to the receiver, Yes, control passes to step 206, which encodes the object relationship information and any other related information, such as frame image data, for transmission. In one example, encoding of common object silhouettes is performed by assigning short codes according to a compression scheme such as Huffman encoding. In another embodiment, common object silhouettes are represented as a bit array encoded into bytes. The encoded data is then transmitted to the receiver.

Control passes from step 206 to step 207, which clears the object relationships list for the receiver. Control returns from step 207 to step 202 and another frame is captured.

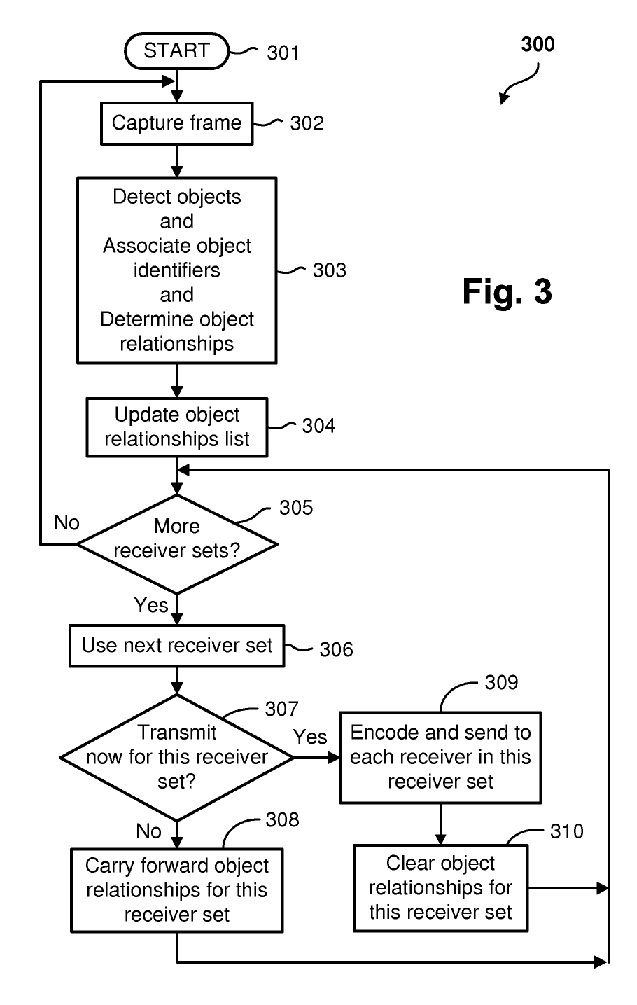

The method 200 of FIG. 2 can be readily extended to multiple receivers, and multiple receiver sets. FIG. 3 is a flowchart illustrating a method 300 for condensing and summarising temporal object relationships for multiple receivers. The method 300 begins at a Start step 301 that initialises the system and control passes to step 302, in which a frame is captured. Control then passes to an object tracking method step 303. The object tracking method step 303 detects objects in the captured frame and associates object identifiers with the detected objects. The object tracking method step 303 also determines object relationships among the detected objects. Such relationships may include, for example, split and merge relationships. As described above, there are many known techniques for performing object tracking.

Control passes from step 303 to step 304, which updates an object relationships list using object relationships information determined in step 303. Control then passes to a decision step 305, which determines whether there are any more receiver sets. If there are no more receiver sets, No, control returns to step 302 to capture the next frame. However, if at step 305 there are more receiver sets, Yes, control passes to step 306 for processing of a receiver set. The decision step 305 effectively defines a loop that allows each receiver set to be visited. The decision step 305 may involve timing or interrupt signals. For example, if another frame has arrived while a previous receiver set is being processed, then decision step 305 may be configured to defer further processing of receiver sets in order to ensure the newly arrived frame is analysed.

At step 306, a next waiting receiver set is retrieved and control passes to decision step 307, which determines whether to transmit accumulated object relationship information to the current receiver set. As described above with respect to step 205 of FIG. 2, step 307 is equivalent to evaluating a transmission criterion. Further, step 205 may optionally be utilised to determine whether or not to transmit one or more frames to the receiver.

If step 307 determines that accumulated relationship information is not yet to be transmitted to a receiver, No, control passes to step 308. Step 308 condenses and summarises the object relationships by utilising an inferred relationships list to carry forward object relationships for the current receiver set. Control returns from step 308 to step 305.

If step 307 determines that accumulated relationship information is to be transmitted to the receiver, Yes, control passes to step 309, which encodes the object relationship information and any other related information, such as frame image data, for transmission. The encoded data is then transmitted to all receivers in the current receiver set.

Control passes from step 309 to step 310, which clears the object relationships list for the receiver. Control returns from step 310 to step 305.

It should be clear to one skilled in the art that there are many other similar systems which interleave the decision steps differently, in order to achieve different timing characteristics. For example, a decision step involving timing or interrupts could be added within step 309 to allow newly captured frames to be processed while deferring transmission to some receivers in the current receiver set. Likewise, transmission criteria for all receiver sets could interact with a priority queue to allow the system to choose readily which receiver set to service next without the need to visit every receiver set each time a frame is captured. This is especially true of transmission criteria which involve fixed time intervals. Such variations are within the spirit and scope of the present disclosure.

Similarly, it should be clear that other behaviours of the camera system can be triggered by the same or similar decision steps as described above. For example, in one embodiment a camera increases its frame rate in response to a merge or split operation or other interesting occurrence. In another embodiment, the camera tracks the motion of a person by swivelling the camera or adjusting the lens to zoom into the motion to prove greater detail or to disambiguate object interactions. Such movement programs can run in conjunction with object summarisation as described above in order to provide high quality object relationship data to receivers.

Likewise, other object information may be gathered and maintained for transmission to receivers in addition to the abovementioned summaries of object interactions. For example, statistics on object motions, sizes, motion paths, entry and exit of objects, abandoning or removal of objects in the scene, and so on, may be kept and then transmitted. In one embodiment, object motions, positions, trajectories, or combinations thereof are used within transmission criteria, or otherwise, to affect the camera operation.

Furthermore, object silhouettes, and optionally object relationships, can be used to selectively send parts of video frames rather than entire frames. For example, just the pixels corresponding to a detected object can be transmitted, or just the pixels of any object which was involved in a merge or a split, or just the pixels of any object from the previous several frames which intersected another object or position within the scene over the previous several frames. Instead of pixels, blocks of pixels, or compressed blocks of pixels can be sent. The information transmitted depends on the particular application.

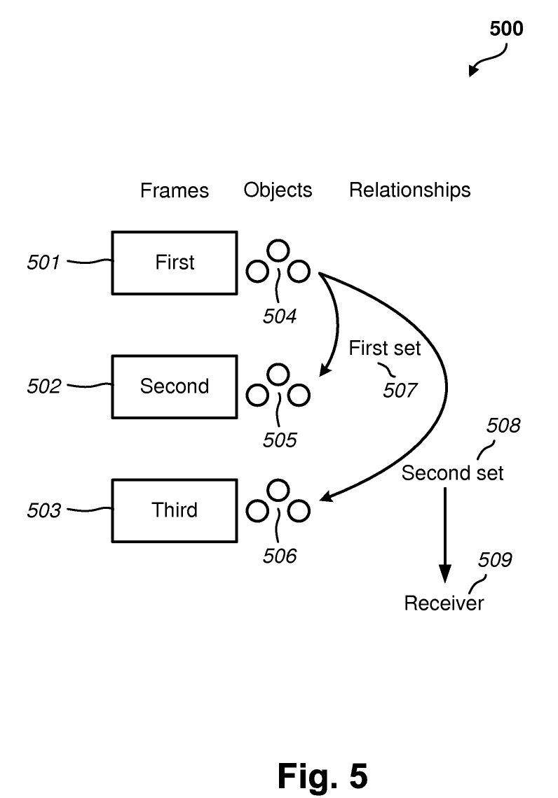

FIG. 5 is a schematic representation of a model 500 of object relationships established in accordance with an embodiment of the present disclosure. The model 500 includes a first video frame 501, a second video frame 502, and a third video frame 503. Each of the first video frame 501, the second video frame 502, and the third video frame 503 is captured and analysed to detect objects. In the example of FIG. 5, a first set of objects 504 is identified in the first video frame 501, a second set of objects 505 is identified in the second video frame 502, and a third set of objects 506 is identified in the third video frame 503.

A first set of temporal object relationships 507 is determined between the first set of objects 504 and the second set of objects 505. This determining step may use the method described above. Alternatively, the determining step may simply utilise an object tracking system known in the art. A second set of temporal object relationships 508 between the first set of objects 504 and the third set of objects 506 is determined using the method disclosed above, using the first set of temporal object relationships 507 as a basis for determining the second set 508. This second set of temporal object relationships 508 is transmitted to at least one receiver 509.

As the first set of temporal object relationships 507 can itself be determined according to the method disclosed herein by using extra intermediate frames, objects and relationships, many summarisations and condensations of the object relationships can occur, and the transmissions need not occur for every frame detected, nor at the same rate for all receivers.

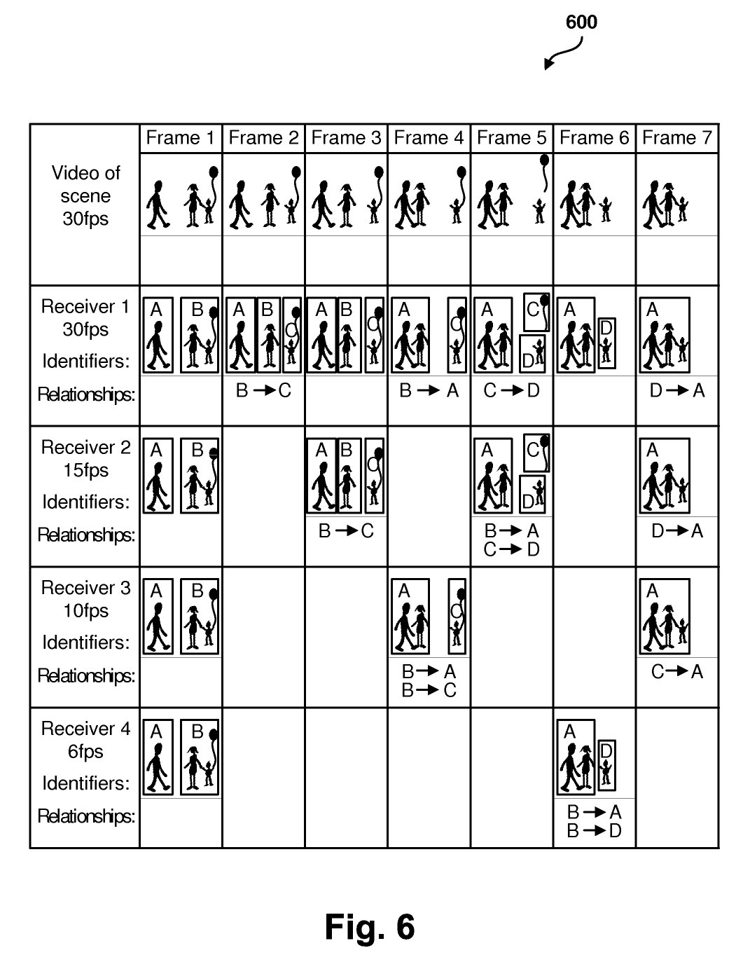

FIG. 6 illustrates operation of an embodiment of the present disclosure, in which an object detection system is configured with multiple receivers. In this particular example, there are four receivers: Receiver 1, Receiver 2, Receiver 3, and Receiver 4. Video images of the scene are captured at 30 frames per second (fps). In one embodiment, video images are captured using a camera as illustrated in FIG. 8. The object detection system is configured to send object identifiers and object relationships to Receiver 1 at the same rate as the images are captured (i.e., 30 fps). The other receivers receive information at different rates, as shown in Table 1.

TABLE 1

| | Rate of Transmission of Object Identifiers |
|---|---|
| Receiver | and Object Relationships to Receiver |
| Receiver 1 | 30 fps |
| Receiver 2 | 15 fps |
| Receiver 3 | 10 fps |
| Receiver 4 | 6 fps |

FIG. 6 depicts seven video frames. The object detection system analyses frame 1 and detects two objects. A first identified object is a man, and is assigned identifier A. A second identified object is a woman with a boy holding a balloon, which are collectively assigned identifier B. The object detection system transmits objects A, B to Receiver 1, but no relationship information, as there is no preceding frame with which to establish relationships.

In frame 2, the woman walks to the left and becomes separated from the boy. This is a “split” relationship. The object detection system assigns the woman the same identifier as utilised in frame 1, namely identifier B, and assigns a new identifier, identifier C, to the boy holding the balloon. The object detection system transmits objects A, B, and C to Receiver 1, along with the split relationship B→C. This split relationship indicates that object B from the previous frame (frame 1, in this example) is a parent of C in the current frame (frame 2). The system could equally have assigned identifier B to the boy and the new identifier C to the woman. Further, there is generally no need to transmit self relationships, such as A→A, since self relationships can be implicitly assumed or deduced by the receiver. Alternatively, in another embodiment, explicit ‘self’ relationships are transmitted.

In frame 3, the woman continues to walk further to the left. As the objects A, B, and C are the same as in the previous frame, frame 2, no new relationship information is transmitted to Receiver 1. Accordingly, only objects A, B, and C are transmitted to Receiver 1, with no additional relationship information.

In frame 4, the woman has moved sufficiently close to the man that the object detection system considers that the man and the woman comprise a single object. This is a “merge” relationship and the object detection system assigns this newly merged object the identifier A. The identifier B is not used in frame 4. The merge relationship is transmitted to Receiver 1 as B→A. In general, there is no need to transmit information to say that B has vanished, since this can be inferred by the receiver due to the lack of its object identifier. Alternatively, an explicit ‘removal’ notice could be transmitted. Note that the system could equally have assigned the merged object identifier B and removed reference to object A in frame 4.

Frame 5 shows that the boy has let go of the balloon and the balloon has floated upwards, resulting in the detection of the balloon as a new object. The object detection system assigns the balloon the object identifier C, and assigns a new identifier D to the boy. As the boy D was previously a part of object C in frame 4, a split relationship is transmitted C→D, which identifies that new object D is a child of object C from the previous frame.

As described above with reference to frames 2 and 4 in respect of the merge relationships, the allocation of identifiers is dependent on the particular application. In this example, the system can equally allocate the existing identifier C to the boy and the new identifier D to the balloon, or in another embodiment both the boy and the balloon are assigned new identifiers. In a further embodiment, new identifiers are utilised for all objects in each current frame being analysed and the relationship information enables users to match objects across successive frames. In such an embodiment, self relationships need to be transmitted to the receivers, because the object identifiers are different in each of the frames.

In frame 6, the boy moves to the left, while the balloon is now absent from the scene. No relationships need to be transmitted here, although an explicit ‘removal’ notice can optionally be sent to indicate that object C (the balloon) has vanished. As noted above, such non-existence messages can instead be inferred by the receiver as a result of only transmitting objects A, B, and D to the receiver.

In frame 7, the boy has moved sufficiently close to the woman to be considered as a single object with the man and woman A. Thus, object D from frame 6 has merged into a combined object A in frame 7. This merge relationship is sent to Receiver 1 as a relationship D→A.

In all cases, the first part of each relationship pair refers to an object detected in the previous frame about which information was sent to that Receiver. The first objects in the relationship pairs are logical parent objects. The second object of each relationship pair refers to an object detected in the current frame. The second objects in the relationship pairs are logical child objects.

FIG. 6 also illustrates the information transmitted to Receiver 2, which receives information at 15 fps. Thus, Receiver 2 receives information for every second frame captured by the camera. As described above, the object detection system analyses frame 1 and detects object A relating to a man and object B relating to a woman with a boy holding a balloon. The object detection system transmits objects A and B to Receiver 2, but no relationship information is transmitted.

The system is configured to transmit information to Receiver 2 at 15 fps, so information is transmitted in this example with respect to frames 1, 3, 5, and 7. In frame 3, the object detection system detects object A relating to a man, object B relating to a woman, and object C relating to a boy holding a balloon. Frame 3 contains object C that was not in frame 1, and object C is a child of object B from frame 1. Thus, the object detection system transmits objects A, B, and C to Receiver 1 and the relationship pair B→C.

At frame 5, the object detection system identifies object A relating to a man and woman, object C relating to a balloon, and object D relating to a boy. With reference to frame 3, which is the frame previously transmitted to Receiver 2, object B relating to the woman in frame 3 has merged into object A of frame 5 and object C of frame 3 has split to form object C and object D. Thus, objects A, C, and D are transmitted to Receiver 2 with respect to frame 5, along with the relationship pairs B→A, and C→D.

In frame 7, the object detection system identified a single object A relating to a man, woman, and a boy. With reference to frame 5, which was the frame previously transmitted to Receiver 2, object D has merged into object A and object D no longer exists. Accordingly, the object detection system transmits object A to Receiver 2 and a single relationship pair D→A.

FIG. 6 also illustrates the information transmitted to Receiver 3, which receives information at 10 fps. Thus, Receiver 3 receives information for every third frame captured by the camera. As described above, the object detection system analyses frame 1 and detects object A relating to a man and object B relating to a woman with a boy holding a balloon. The object detection system transmits objects A and B to Receiver 3, but no relationship information is transmitted.

The system is configured to transmit information to Receiver 3 at 10 fps, so information is transmitted in this example with respect to frames 1, 4, and 7. In frame 4, the object detection system detects object A relating to a man and a woman, and object C relating to a boy holding a balloon. Frame 4 contains object C that was not in frame 1, and object C is a child of object B from frame 1. Further, object B from frame 1 has merged into object A of the current frame, frame 4. Thus, the object detection system transmits objects A and C to Receiver 3 and the relationship pairs B→A and B→C.

In frame 7, the object detection system identified a single object A relating to a man, woman, and a boy. With reference to frame 4, which was the frame previously transmitted to Receiver 3, object C has merged with object A. Accordingly, the object detection system transmits object A to Receiver 3 and a single relationship pair C→A.

FIG. 6 also illustrates the information transmitted to Receiver 4, which receives information at 6 fps. Thus, Receiver 4 receives information for every fifth frame captured by the camera. As described above, the object detection system analyses frame 1 and detects object A relating to a man and object B relating to a woman with a boy holding a balloon. The object detection system transmits objects A and B to Receiver 4, but no relationship information is transmitted.

The system is configured to transmit information to Receiver 4 at 6 fps, so information is transmitted in this example with respect to frames 1 and 6. In frame 6, the object detection system identified object A relating to a man and a woman, and object D relating to a boy. With reference to frame 1, which was the frame previously transmitted to Receiver 4, object B has merged with object A and object B has split to form a child object D. Accordingly, the object detection system transmits object A and object D to Receiver 4 and relationship pairs B→A and B→D.

Due to the summarisation process described above, it can be seen that only information relevant to a particular receiver is sent to that receiver, and hence the relationships which are sent to a particular receiver can differ from relationships that are sent to another receiver. For example, with reference to FIG. 6, the third frame transmitted to Receiver 3 is the fourth frame transmitted to Receiver 2 and is the seventh frame transmitted to Receiver 1. The relationships sent to Receiver 3 regarding that frame (C→A) differ from the relationships sent to Receiver 2 (D→A) or Receiver 1 (D→A). This is because the low frame rate of Receiver 3 means that Receiver 3 does not see the intermediate object D, which relates to the child without a balloon, and accordingly Receiver 3 is not informed of intermediate object D. Yet, the relationships are preserved within the object relationships list described above, and so the relationships are transmitted despite the lower transmission rate. The information object information and object relationship information transmitted to Receiver 3 allows Receiver 3 to know that object C from frame 4 (the second frame transmitted to Receiver 3) merged into object A in frame 7.

Similarly, the relationships which Receiver 4 receives regarding frame 6 (the second frame transmitted to Receiver 4) are markedly different from the relationships transmitted to Receiver 1 for the same frame, yet each set is relevant to the appropriate receiver.

In this example, the frames themselves need not be sent. It may suffice merely to send information about the objects detected, perhaps consisting of as little information as a list of object identifiers. Alternatively, more information may be sent, including object outlines, centroids, or other data, including the corresponding pixels or entire video frames.

The relationships described above may be encoded in any reasonable format for transmission. One way is to use the notation given above. For example, consider the relationships that Receiver 2 of FIG. 6 receives for its third frame (frame 5):
B→A
C→D

Another way to represent such relationships is to use XML code:

```
<object id=“A”>
  <parent id=“B”>
</object>
<object id=“C” />
<object id=“D”>
  <parent id=“C”>
</object>
```

In the above examples, self relationships are implicit. Alternatively, self relationships are transmitted explicitly, as shown in the XML code below:

```
<object id=“A”>
  <parent id=“A”>
  <parent id=“B”>
</object>
<object id=“C”>
  <parent id=“C”>
</object>
<object id=“D”>
  <parent id=“C”>
</object>
```

Note, the above code involves transmitting relationship information for object C, which was previously implicit in its mere existence.

Similarly, explicit object removal messages may be optionally transmitted:
<object id=“B” status=“gone” />

If removal messages are transmitted, it may not be necessary to transmit other information, since the receiver will be able to deduce the equivalent meaning. For example, the following line, which includes an implicit self relationship, can be elided, since the receiver can assume that if the receiver has not been informed that the object has vanished, then the receiver may assume the object is still extant:
<object id=“C” />

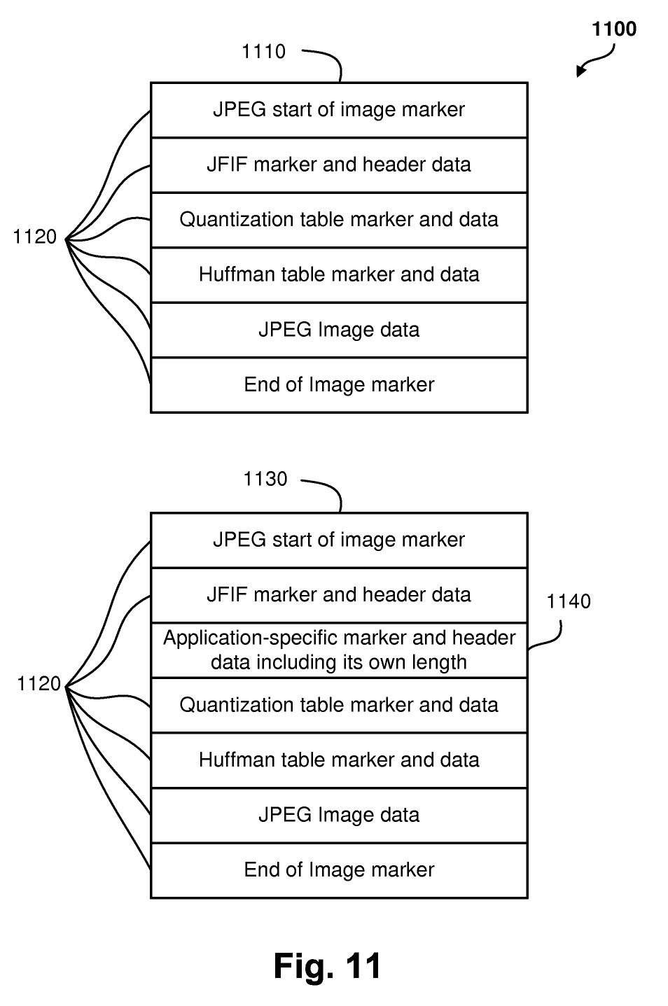

An alternative format for representing and transmitting such information is to employ a JPEG header extension mechanism which allows application-specific data blocks to be inserted into a JPEG file. FIG. 11 shows a process 1100 of modifying an existing JPEG file 1110 by inserting a new data block 1140 into the JPEG file 1110. The existing JPEG file 1110 contains a number of data blocks 1120. A method of inserting a new data block 1140 holding relationship data into such a JPEG file is as follows. First, space is made in a modified file 1130 in an appropriate place in the JPEG data structure for the new data block 1140. If necessary, some of the existing data blocks 1120 are moved to make room for the new data block 1140. Then, the contents of the new data block 1140 are copied into the space which has been made in the modified file 1130. This newly inserted data block 1140 includes an identifier (e.g., a two byte number such as 0xFFE8) and a number holding the size in bytes of the newly added data block so that other applications which do not understand the additional data can simply skip over the data block when reading the file. Such additional application-specific data blocks 1140 as could be added to an existing JPEG file 1110 using such a method as described above could be used to hold XML as discussed above or an alternative format which may be more compact but may be less human-readable.

Such representations as discussed above may be equivalent to other encodings using implicit or explicit transmission of information. All such equivalent encodings may equally be practised without departing from the spirit and scope of the present disclosure.

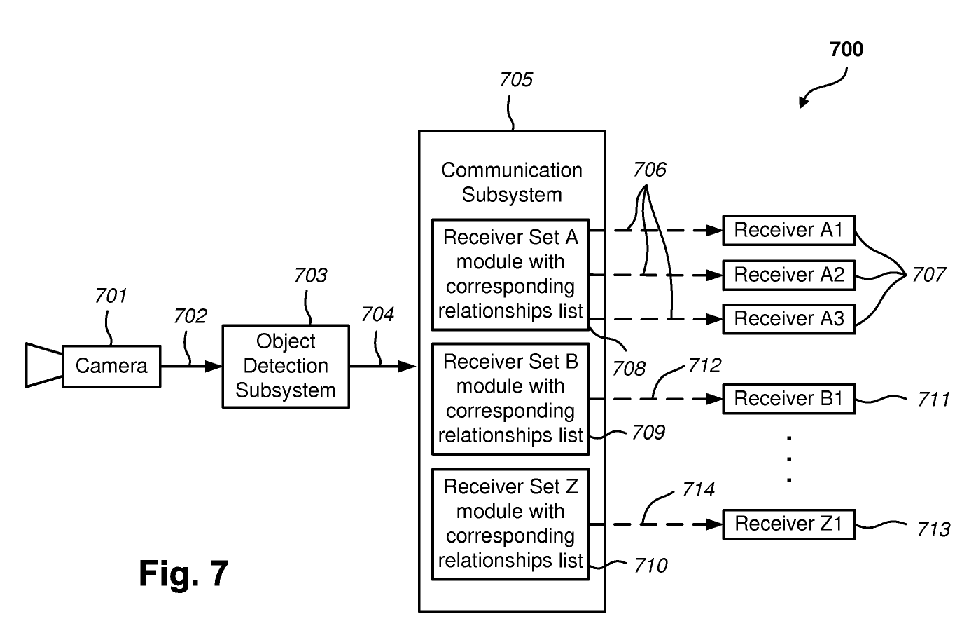

FIG. 7 is a block diagram showing a an embodiment of a camera system in accordance with the present disclosure having multiple receiver sets. In particular, FIG. 7 shows a system 700 that includes multiple receiver sets, with one or more receivers in each receiver set. The system 700 includes a camera 701 that captures frames and passes data via an electrical or other data connection 702 to an Object Detection Subsystem 703. The Object Detection Subsystem performs object tracking and assigns object identifiers to detected objects. Output data from the Object Detection Subsystem 703 is then sent via an electrical or other data connection 704 to a Communication Subsystem 705, which maintains information for one or more Receiver Sets 708, 709, 710.

Each receiver set has an associated relationship list, which is built and maintained in accordance with the method(s) described above. The Communication Subsystem 705 passes detected, inferred or deduced information, via a communications channel, to each receiver which is associated with an appropriate receiver set. In one embodiment, the communications channel is a network connection. In another embodiment, the communications channel is a hardwired transmission link. In a further embodiment, the communications channel is a wireless transmission link. This method of condensing and summarising temporal object relationships for multiple receivers is as described above with reference to the flowchart of FIG. 3, which involves the evaluation of a transmission criterion for each receiver set.

One or more receivers can be associated with each receiver set. A receiver set can even have zero receivers associated therewith, since the receiver set may be awaiting connections to that receiver set. In one embodiment, receiver sets and receiver connections are created on demand. In another embodiment there are a limited number of receiver sets. In one example, limits on the number of receiver sets are determined by hardware restrictions, performance requirements, or other criteria.

In the example of FIG. 7, the Communication Subsystem 705 includes a Receiver Set A 708, a Receiver Set B 709, and a Receiver Set Z 710. Three receivers (Receiver A1, Receiver A2, and Receiver A3) 707 are associated with Receiver Set A 708. Receiver A1, Receiver A2 and Receiver A3 707 are coupled to the Receiver Set A 708 by a communications channel 706. The communications channel 706 can be implemented using a single communications channel to link all of the receivers 707 with the Receiver Set A 708 or alternatively a plurality of communications channels 706 can be implemented to couple the receivers 707 with the Receiver Set A 708.

A Receiver B1 711 is associated with the Receiver Set B 709. Receiver B1 711 is coupled to the Receiver Set B 709 by a communications channel 712. Similarly, a Receiver Z1 713 is associated with the Receiver Set Z 710. Receiver Z1 713 is coupled to the Receiver Set Z 710 by a communications channel 714.

In one configuration, the communication subsystem immediately starts transmitting information that all other receivers in a receiver set are receiving to receivers which have been newly added to that receiver set. Alternatively, the communication subsystem transmits an initial burst of information to a newly added receiver to establish a current state of the object detection subsystem. This latter approach may be necessary in some applications to ensure than any inferences made by that newly added receiver, based on implicit or contextual information, are correct. Additionally, a first message in accordance with the relationships lists method described above may be special or different to account for the fact the system is initialising and has not yet deduced any relationships. Such an arrangement may occur, for example, if the object detection subsystem has only processed a single frame of video.

New receivers may be added or existing receivers removed from receiver sets during the operation of the system. The addition or removal of one or more receivers from the system can be effected via commands and requests which are well known in the art of networking. For example, in one embodiment a receiver may request to join a new receiver set using an HTTP POST request with XML code representing an “open” command:

<open />

Alternatively, a receiver may request to join an existing receiver set using an HTTP POST request with XML code that names a session with which a receiver set is associated:

<open session=“X” />

A receiver may request to be removed from its receiver set using an HTTP POST request with XML code representing a “close” command:

<close />

Receivers can be software programs, hardware devices, or a combination thereof. The ability to transmit to multiple receivers supports such purposes as redundant security storage servers, and roaming security guards watching for alerts on portable video phones. The ability to have multiple receiver sets supports different frame rates or features for each receiver set. For example, security guards might use a lower frame rate or resolution on their video phones, as compared with a security video storage server, yet both require appropriate information and desire not to miss important events.

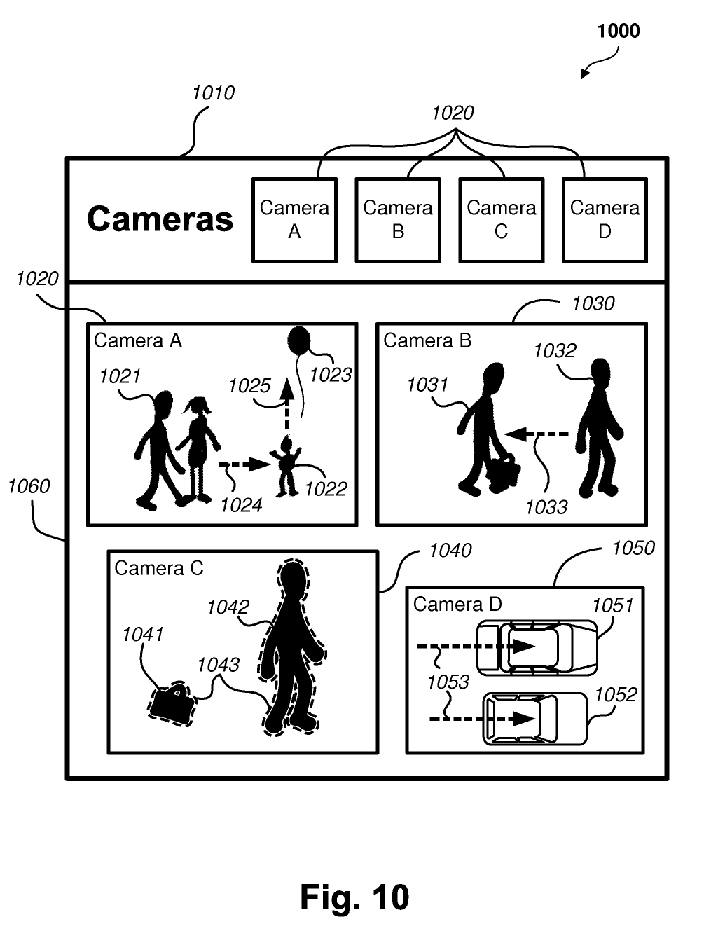

FIG. 10 shows one implementation of a graphical user interface 1000 for displaying object relationships transmitted to a receiver and displayed thereon. A display window 1010 may display icons 1020 showing various cameras which can be viewed live in a display area 1060.

A first camera view 1020 illustrates split relationships. In the example shown, a couple 1021 is shown with their son 1022 and a balloon 1023, while some object relationships are shown as arrows 1024, 1025. In one embodiment, the arrows show parent-child object relationships resulting from a split. For example, the balloon 1023 is a child of the son 1022, so the arrow 1025 relating those two detected objects points from the parent object 1022 to the child object 1023. The object that is considered to be the parent and the object that is considered to be the child may depend on the specifics of the object tracking method and how new object identifiers are assigned, but several methods are possible, including arbitrary assignment, assignment based on motion, motionlessness, size, proximity to a nominal point in the scene (e.g., top-left corner of a scene), and so on.

A second camera view 1030 illustrates merge relationships. In the example shown, a first person on the left 1031 has picked up a bag which was previously dropped by a second person on the right 1032. The object tracking method has determined that some object has been transferred from the second person on the right 1032 to the first person on the left 1031, and is illustrating that merge relationship with an arrow 1033. In this case, there may be no new object identifiers produced, but the relationship can still be shown using arrows.

A third camera view 1040 illustrates a relationship using borders around objects. A bag 1041 is visible in the scene next to a person 1042. Borders 1043 are drawn around both objects. The presence of such borders, or their colours or other properties of those borders, can be used to indicate relationships between the objects. For example, if the person 1042 dropped the bag 1041 this would be a split, so the colours of the borders 1043 could begin as the same colour, but over time gradually change to different colours to indicate the time which has elapsed since the last relationship between those two objects was detected. Similarly, when viewing pre-recorded footage, upcoming object mergers could be indicated via border colours which gradually become more similar as the merge nears in time. This approach requires analysis of footage in advance, or delayed viewing of video frames. It solves one problem with using arrows to indicate merge operations, in that merges often occur between objects which are spatially close and thus arrows drawn between objects may be too short to see effectively.

A fourth camera view 1050 illustrates self relationships using arrows. In this example, two cars 1051 and 1052 both have self relationships, meaning they were each seen in a previous frame but were distinct, so there was no split or merge. This is the usual situation with vehicular traffic. Drawing self relationships using arrows can be difficult unless one draws the arrow from the previous position of the same object, for example using centroids. This allows an object to be related to one of its previous positions within the scene without having to show the object at both that previous position and its current position. As a side effect of such a visualisation technique, the relative speeds of objects may be visualised.

One or more embodiments of the present disclosure may be implemented using the camera arrangement 800 of FIG. 8, wherein the processes of FIGS. 1 to 7 may be implemented as software, such as one or more application programs 810 executable within the camera system 800. In particular, the summarising and condensing temporal object relationships method steps are effected by instructions in the software that are carried out within the camera system 800. The instructions may be formed as one or more code modules, each for performing one or more particular tasks. The software may also be divided into two separate parts, in which a first part and the corresponding code modules performs the summarising and condensing temporal object relationships methods and a second part and the corresponding code modules manage a user interface between the first part and the user.

The software may be stored in a computer readable medium, including the memory 806. The software is loaded into the camera system 800 from the computer readable medium, and then executed by the camera system 800. A computer readable medium having such software or computer program recorded on it is a computer program product. The use of the computer program product in the camera system 800 preferably effects an advantageous apparatus for practicing an approach for summarising and condensing temporal object relationships.

The camera system 800 also has an interface 808 which permits coupling of the camera subsystem 801 to the network 814.

Typically, application programs for identifying, summarising, and condensing temporal object relationships, as discussed above, are resident in the memory 806 and read and controlled in execution by the processor 805. In some instances, the application programs for identifying, summarising, and condensing temporal object relationships may be supplied to the user encoded on one or more CD-ROM which can be loaded onto a PC (not shown) and downloaded onto the camera subsystem 801 through a suitable interface (not shown), or alternatively may be read by the user from the network 814. Still further, the software can also be loaded into the computer system 800 from other computer readable media.

Computer readable media refers to any storage or transmission medium that participates in providing instructions and/or data to the computer system 800 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the camera subsystem 801.

Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon a camera display (not shown). Through manipulation of a keypad (not shown) a user of the camera system 800 and the application may manipulate the interface to provide controlling commands and/or input to the applications associated with the GUI(s).

The method for summarising, and condensing temporal object relationships may alternatively be implemented in dedicated hardware such as one or more integrated circuits performing the functions or sub functions of identifying, summarising, and condensing temporal object relationships. Such dedicated hardware may include graphic processors, digital signal processors, or one or more microprocessors and associated memories.

### INDUSTRIAL APPLICABILITY

It is apparent from the above that the arrangements described are applicable to the data processing and imaging industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

What is claimed is:

1. A method of communicating video object relationships, comprising the steps of:
(a) detecting one or more objects in a first video frame;
(b) detecting one or more objects in a second video frame;
(c) determining a first set of temporal object relationships between said objects detected in said second video frame and said objects detected in said first video frame;
(d) detecting one or more objects in a third video frame;
(e) determining a second set of temporal object relationships between said objects detected in said third video frame and said objects detected in said first video frame, based on said first set of temporal object relationships; and
(f) transmitting said second set of temporal object relationships to a receiver.

2. The method according to claim 1, comprising the further steps of:
(g) detecting one or more objects in an intermediate frame between said first and said second video frames;
(h) determining an extra set of temporal object relationships between said objects from said intermediate video frame and said objects detected in said first video frame; and
wherein said first set of temporal object relationships are determined in step (c), based on said objects detected in said intermediate video frame and said extra set of temporal object relationships.

3. The method according to claim 1, wherein said determination in step (e) comprises the further steps of:
(i) determining one or more self and parent relationships between said objects detected in said second video frame to one or more of said objects detected in said first video frame to determine said first set of temporal object relationships;
(j) determining object self relationships between said objects in said third video frame and one or more said objects detected in said first video frame,
(k) deducing object self relationships between said objects detected in said second video frame and said objects detected in said third video frame using said self relationships from steps (i) and (j); and
(l) establishing a set of object parent relationships for each said object detected in said third video frame, such that the parents of each said object are determined by combining the said self relationships deduced in step (k) with the said parent relationships from step (i).

4. The method according to claim 3, wherein:
the first video frame, and data describing objects detected in said first video frame, are transmitted to the receiver; and
the third video frame, and data describing objects detected in said third video frame, are transmitted to the receiver with the second set of temporal object relationships.

5. The method according to claim 3, wherein:
there is a plurality of receivers;
each said receiver is associated with a receiver set;
each said receiver set has an associated transmission criterion; and
the said second set of temporal object relationships is transmitted to all said receivers within a receiver set only whenever said transmission criterion associated with said receiver set is evaluated as true.

6. The method according to claim 5, wherein the said transmission criterion evaluates to true if a time threshold has elapsed since the previous transmission to said receiver set.

7. The method according to claim 5, wherein the said transmission criterion evaluates to true if the said first set of object relationships contains at least one of a split relationship and a merge relationship.

8. The method according to claim 5, wherein the said transmission criterion evaluates to true if:
(m) the said first set of object relationships contains a parent relationship; and
(n) the said second set of object relationships contains a parent relationship deduced from the information in step (m).

9. The method according to claim 5, wherein the said transmission criterion evaluates to true if at least one of said objects detected in said third video frame overlaps a specified region within the frame.

10. The method according to claim 5, wherein the said transmission criterion includes at least one of the status of the camera, object detection, and communication subsystems.

11. The method according to claim 10, wherein the said status involves a low memory situation.

12. The method according to claim 10, wherein the said status involves at least one of a change to a direction of the camera and a change to a setting of a lens.

13. The method according to claim 6, wherein there are two or more of said receiver sets, each of which has a said transmission criterion which uses a different time interval from each other.

14. The method according to claim 1, wherein information is also transmitted concerning any said objects detected in said second video frame which are not related by any self relationships to any said objects in said first and third video frames.

15. The method according to claim 5, wherein if the said transmission criterion evaluates to true then transmission of video frames of a predefined resolution is initiated to receivers associated with said receiver set.

16. A system comprising:
a source of video frames;
an object detection subsystem for receiving video frames from said camera and detecting objects in said video frames, said object detection subsystem including a tracking means for determining relationship information between detected objects in a current video frame and objects detected in at least one preceding video frame; and
a communication subsystem for transmitting said relationship information to a receiver.

17. The system according to claim 16, wherein said source of video frames is a video camera.

18. The system according to claim 16, wherein said receiver is associated with a receiver set, said receiver set having an associated temporal criterion for determining when relationship information is transmitted to each receiver in said receiver set.
